(19) United States
(12) Patent Application Publication
(10) Pub. No.: US 2026/0134370 A1
(43) Pub. Date: May 14, 2026

(54) Risk Analysis Method and Risk Analysis System

(71) Applicant: Hitachi, Ltd., Tokyo (JP)

(72) Inventors: Ken NAONO, Tokyo (JP); Mika Takata, Tokyo (JP); Tsunehiko Baba, Tokyo (JP); Keita Mizushina, Tokyo (JP); Ken Sugimoto, Tokyo (JP); Hiroaki Masuda, Tokyo (JP); Mayuko Ozawa, Tokyo (JP)

(21) Appl. No.: 19/191,023

(22) Filed: Apr. 28, 2025

(30) Foreign Application Priority Data
Nov. 12, 2024 (JP) 2024-197574

(51) Int. Cl. G06Q 10/0635; G06Q 10/087

(52) U.S. Cl. CPC G06Q 10/0635; G06Q 10/087

(57) ABSTRACT

It is intended to clarify an item to be normally executed in order to reduce a risk in an emergency. In a risk analysis method, a risk analysis system defines a plurality of normal-time objective functions each of which is an objective function representing an objective to be normally achieved and has, as input to a predetermined function that outputs a predetermined value in response to the input, a predetermined equation that includes, as first-order terms or factors, a plurality of explanatory factors each multiplied by a first contribution degree relating to the relevant explanatory factor. Further, the risk analysis system defines an emergency-time objective function that is an objective function representing an objective to be achieved in order to reduce the risk, as a function that outputs a value in response to input, the input being a predetermined equation including, as first-order terms or factors, the plurality of normal-time objective functions each multiplied by a second contribution degree relating to the relevant normal-time objective function. In addition, the risk analysis system outputs the second contribution degrees in the emergency-time objective function through machine learning of second sample data relating to the emergency-time objective function and extracts, on the basis of the second contribution degrees, a prioritized normal-time objective function to be optimized with priority from the normal-time objective functions.

### BACKGROUND OF THE INVENTION

### 1. Field of the Invention

The present invention relates to a risk analysis method and a risk analysis system.

### 2. Description of the Related Art

For example, JP-2022-149246-A discloses a technology of causing, in a power supply system provided with a power generation unit including a fuel cell, in a case in which an earthquake having a set magnitude is predicted to arrive in a designed length of time, the power generation unit to stop power generation not through emergency stop processing but through normal stop processing including a temperature reduction step for the power generation unit. By clarifying a countermeasure to take in an emergency in this way, it is possible to reduce such a risk in an emergency as deterioration of the power generation unit.

### SUMMARY OF THE INVENTION

However, the related art described above only indicates the countermeasure to take in an emergency such as executing the normal stop processing in place of the emergency stop processing under certain conditions in the event of an earthquake, and does not clarify an item to be normally executed in order to reduce the risk in an emergency.

The present invention has been made in view of the situation described above and has as an objective thereof clarification of an item to be normally executed in order to reduce the risk in an emergency.

As one aspect for solving the problem described above, there is provided a risk analysis method executed by a risk analysis system that executes risk analysis for reducing a risk that occurs in an emergency. The risk analysis method includes, by a processor of the risk analysis system, defining a plurality of normal-time objective functions each of which is an objective function representing an objective to be normally achieved and has, as input to a predetermined function that outputs a predetermined value in response to the input, a predetermined equation that includes, as first-order terms or factors, a plurality of explanatory factors each multiplied by a first contribution degree relating to the relevant explanatory factor. The risk analysis method further includes, by the processor, defining an emergency-time objective function that is an objective function representing an objective to be achieved in order to reduce the risk, as a function that outputs a value in response to input, the input being a predetermined equation including, as first-order terms or factors, the plurality of normal-time objective functions each multiplied by a second contribution degree relating to the relevant normal-time objective function. The risk analysis method further includes, by the processor, outputting the second contribution degrees in the emergency-time objective function through machine learning of second sample data relating to the emergency-time objective function and extracting, on the basis of the second contribution degrees, a prioritized normal-time objective function to be optimized with priority from the normal-time objective functions.

According to the present invention, for example, it is possible to clarify an item to be normally executed in order to reduce the risk in an emergency.

### BRIEF DESCRIPTION OF THE DRAWINGS

FIG. 1A is a diagram for illustrating a configuration of a normal-time most prioritized countermeasure selection system according to a first embodiment;

FIG. 1B is a diagram for illustrating a hardware configuration of the normal-time most prioritized countermeasure selection system according to the first embodiment;

FIG. 2 is a flowchart for illustrating normal-time most prioritized countermeasure selection processing according to the first embodiment;

FIG. 3A is a view for illustrating a normal-time most prioritized countermeasure selection screen according to the first embodiment;

FIG. 3B is a view for illustrating the normal-time most prioritized countermeasure selection screen according to the first embodiment;

FIG. 3C is a view for illustrating the normal-time most prioritized countermeasure selection screen according to the first embodiment;

FIG. 3D is a view for illustrating the normal-time most prioritized countermeasure selection screen according to the first embodiment;

FIG. 3E is a view for illustrating the normal-time most prioritized countermeasure selection screen according to the first embodiment; and

FIG. 4 is a diagram for illustrating a normal-time objective function group, an emergency-time objective function, and explanatory factors according to a second embodiment.

### DESCRIPTION OF THE PREFERRED EMBODIMENTS

A description is now given of embodiments of the present invention with reference to the drawings.

### First Embodiment

In a first embodiment, in order to achieve, as an objective, prevention of a risk of aggravation of an infected person of an infection in the event of an infection pandemic, countermeasures to be normally taken by people before the occurrence of the infection pandemic are searched for and presented.

In the first embodiment, an emergency-time objective function G(x) to be minimized is an “aggravation probability of the infection during the infection pandemic.” Moreover, in the first embodiment, a normal-time objective function Fi(x) that is based on explanatory factors Ej(x) being data representing a health state of each subject and that should be minimized is an “onset probability of diabetes,” an “onset probability of hypertension,” or the like, which represents an infection situation of disease of each subject. Note that i=1, 2, . . . , N, and j=1, 2, . . . , m. The explanatory factors Ej(x) for each subject include a “value of HbA1c≥6.5,” a “value of systolic blood pressure≥140,” and the like and are information based on a medical examination, an answer to inquiry, information on diagnosis and prescription, and the like targeting each subject.

### (Configuration of Normal-Time Most Prioritized Countermeasure Selection System 1 According to First Embodiment)

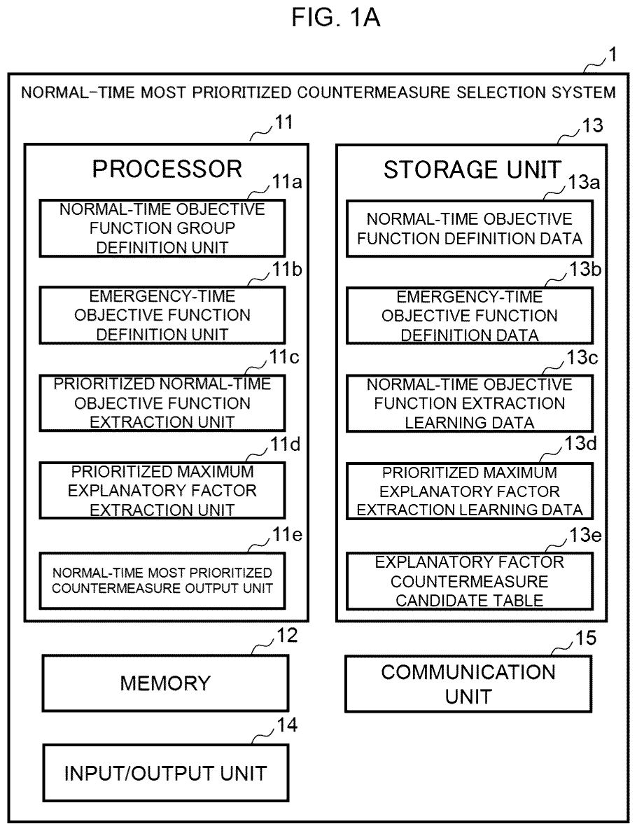

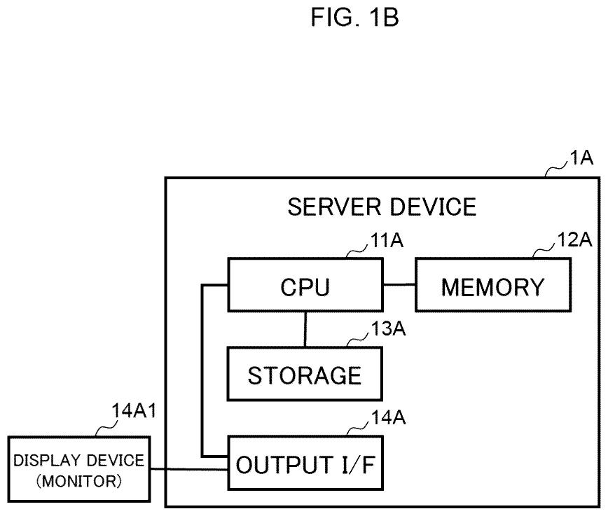

FIG. 1A is a diagram for illustrating a configuration of a normal-time most prioritized countermeasure selection system 1 according to the first embodiment. The normal-time most prioritized countermeasure selection system 1 is a computer including a processor 11, a memory 12, a storage unit 13, an input/output unit 14, and a communication unit 15. The normal-time most prioritized countermeasure selection system 1 is an example of a risk analysis system that executes risk analysis for reducing a risk occurring in an emergency.

The processor 11 is a central processing unit (CPU) or the like that executes programs in cooperation with the memory 12, thereby implementing the respective function units. The processor 11 includes a normal-time objective function group definition unit 11a, an emergency-time objective function definition unit 11b, a prioritized normal-time objective function extraction unit 11c, a prioritized maximum explanatory factor extraction unit 11d, and a normal-time most prioritized countermeasure output unit 11e.

The normal-time objective function group definition unit 11a defines a plurality of the normal-time objective functions Fi(x) that are objective functions representing objectives to be normally achieved. The normal-time objective functions Fi(x) each have, as input to a predetermined function (for example, a sigmoid function) that outputs a predetermined value in response to the input, a predetermined equation that includes, as first-order terms or factors, the plurality of explanatory factors Ej(x) each multiplied by a contribution degree qij (first contribution degree) relating to the relevant explanatory factor Ej(x). Here, the predetermine equation is, for example, qi1×E1(x)+ . . . +qim×Em(x) of Equation (1-1) to Equation (1-n) described later.

The emergency-time objective function definition unit 11b defines the emergency-time objective function G(x) that is an objective function representing an objective to be achieved in order to reduce the risk occurring in an emergency (infection aggravation during an infection pandemic). The emergency-time objective function G(x) is a function that outputs a value in response to input, the input being a predetermined equation including, as first-order terms or factors, the plurality of normal-time objective functions Fi(x) each multiplied by a contribution degree wj (second contribution degree) relating to the relevant normal-time objective function Fi(x). Here, the predetermine equation is, for example, w1×F1(x)+ . . . +WN×FN(x) of Equation (2) described later.

The prioritized normal-time objective function extraction unit 11c outputs the contribution degrees wj in the emergency-time objective function G(x) through machine learning of second sample data (for example, normal-time objective function extraction learning data 13c) relating to the emergency-time objective function G(x). Then, the prioritized normal-time objective function extraction unit 11c extracts, on the basis of the contribution degrees wj, a prioritized normal-time objective function Fs(x) to be optimized with priority from the normal-time objective functions Fi(x).

The prioritized maximum explanatory factor extraction unit 11d outputs the contribution degrees qij in the prioritized normal-time objective function Fs(x) through machine learning of first sample data (for example, prioritized maximum explanatory factor extraction learning data 13d) relating to the prioritized normal-time objective function Fs(x). Then, the prioritized maximum explanatory factor extraction unit 11d extracts the explanatory factors corresponding to a predetermined number of the contribution degrees qij in a descending order (the first to N-th largest contribution degrees qij; N is a natural number).

The normal-time most prioritized countermeasure output unit 11e manages, in an explanatory factor countermeasure candidate table 13e described later, the explanatory factors Ej(x) and countermeasure candidates for reducing the risk in association with each other. The normal-time most prioritized countermeasure output unit 11e refers to the explanatory factor countermeasure candidate table 13e to acquire the countermeasures corresponding to the explanatory factors extracted by the prioritized maximum explanatory factor extraction unit 11d and outputs the acquired countermeasures.

The storage unit 13 is a storage device that stores programs and various types of data. The storage unit 13 stores normal-time objective function definition data 13a, emergency-time objective function definition data 13b, the normal-time objective function extraction learning data 13c, the prioritized maximum explanatory factor extraction learning data 13d, and the explanatory factor countermeasure candidate table 13e.

The input/output unit 14 includes an input device such as a keyboard and a mouse and an output device such as a display. On the display of the input/output unit 14, there is displayed a normal-time most prioritized countermeasure selection screen 13D describe later. The communication unit 15 is a communication device used at the time of communication of the normal-time most prioritized countermeasure selection system 1 with another computer.

### (Hardware Configuration of Normal-Time Most Prioritized Countermeasure Selection System 1)

FIG. 1B is a diagram for illustrating a hardware configuration of the normal-time most prioritized countermeasure selection system 1 according to the first embodiment. The normal-time most prioritized countermeasure selection system 1 is built on a server device 1A. The server device 1A includes a CPU 11A, a memory 12A, a storage 13A, and an output interface (I/F) 14A. The CPU 11A executes programs in cooperation with the memory 12A, thereby implementing the respective function units of the normal-time most prioritized countermeasure selection system 1 illustrated in FIG. 1A.

The server device (storage) 1A stores, in the storage 13A, the normal-time objective function definition data 13a, the emergency-time objective function definition data 13b, the normal-time objective function extraction learning data 13c, and the prioritized maximum explanatory factor extraction learning data 13d. Moreover, the server device (storage) 1A stores, in the storage 13A, the explanatory factor countermeasure candidate table 13e and various setting parameters for hardware operations.

To the server device 1A, a display device (monitor) 14A1 is connected via the output I/F 14A. The server device 1A displays, on the display device (monitor) 14A1, the normal-time objective functions Fi(x), the emergency-time objective function G(x), the prioritized normal-time objective function Fs(x), a prioritized maximum explanatory factor qst, and normal-time most prioritized countermeasures Mt, which are described later.

### (Normal-Time Most Prioritized Countermeasure Selection Processing)

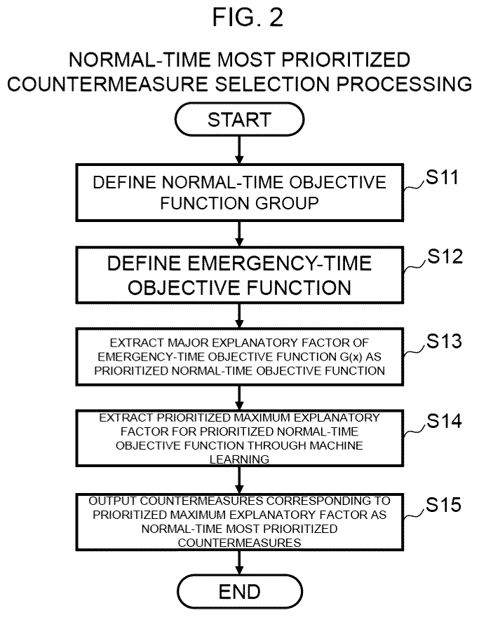

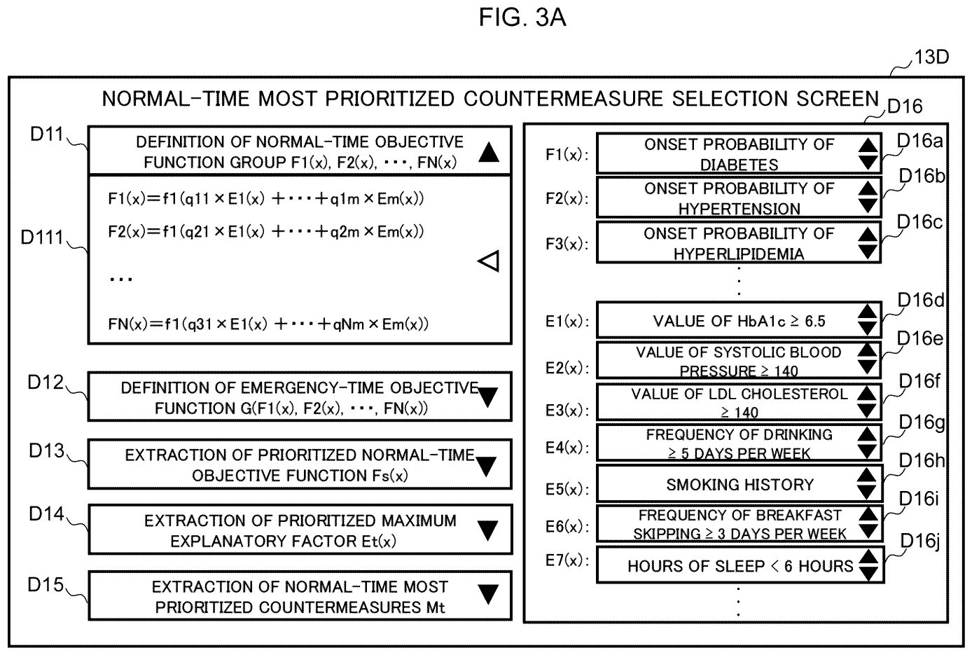

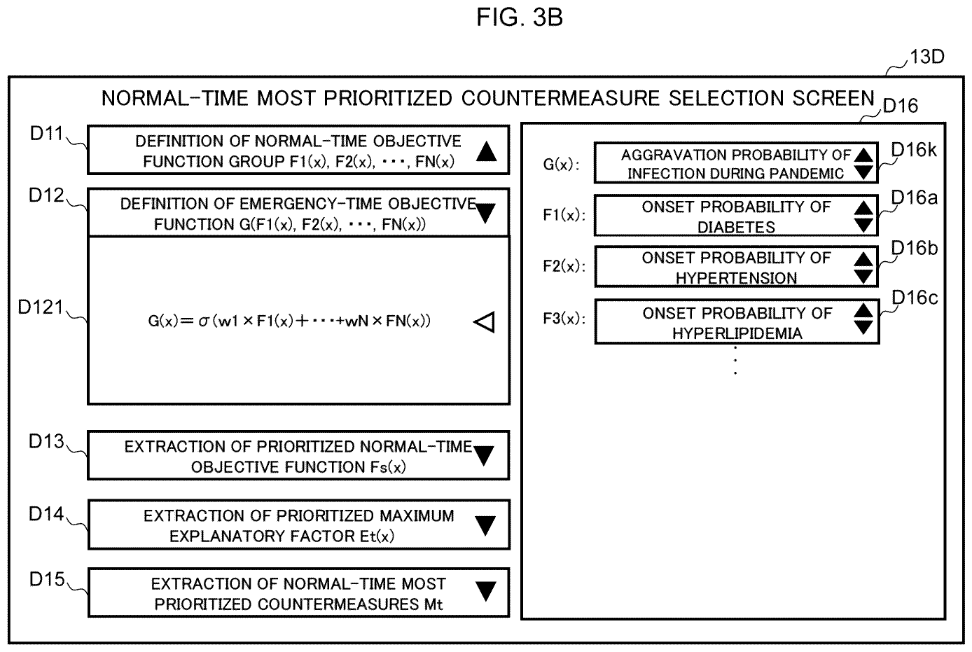

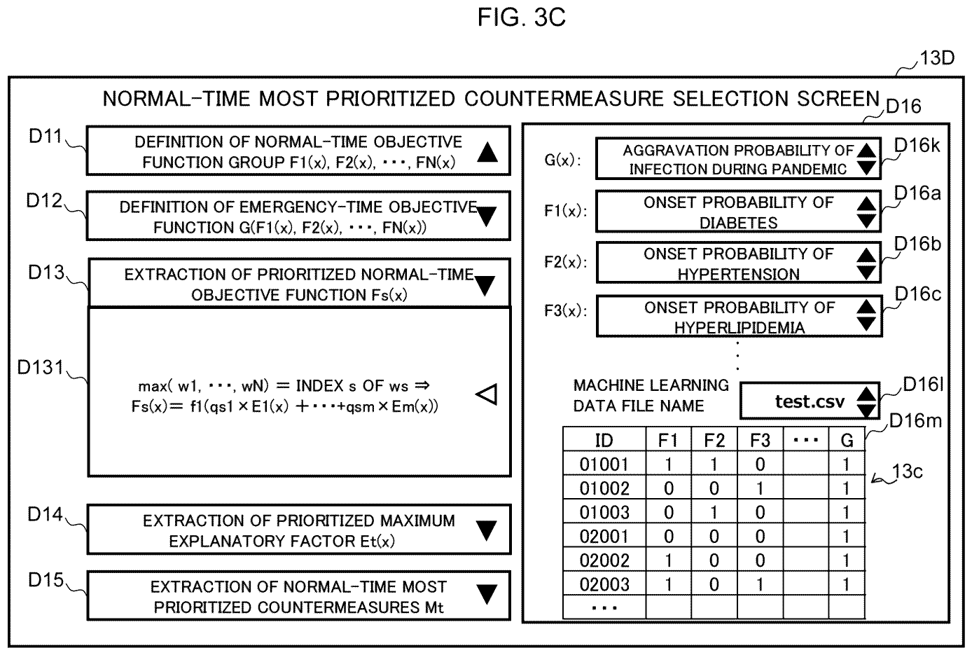

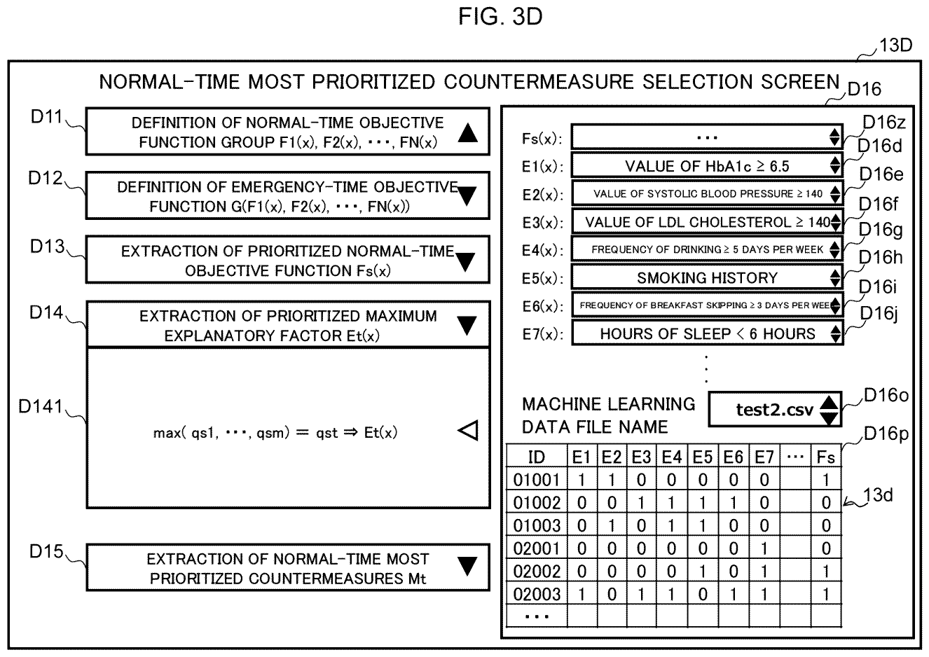

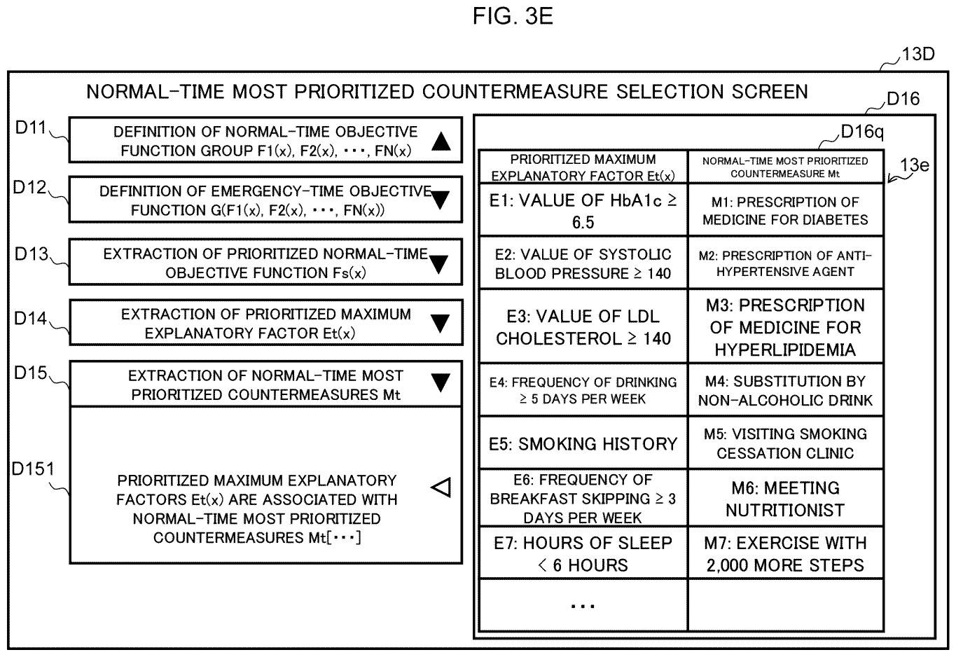

FIG. 2 is a flowchart for illustrating normal-time most prioritized countermeasure selection processing according to the first embodiment. FIG. 3A to FIG. 3E are views for illustrating the normal-time most prioritized countermeasure selection screen 13D according to the first embodiment. The normal-time most prioritized countermeasure selection screen 13D includes, for example, a normal-time objective function group definition box D11, an emergency-time objective function definition box D12, a prioritized normal-time objective function extraction box D13, and a prioritized maximum explanatory factor extraction box D14 as illustrated in FIG. 3A. Moreover, the normal-time most prioritized countermeasure selection screen 13D includes, for example, a normal-time most prioritized countermeasure extraction box D15 and a selection field D16 as illustrated in FIG. 3A.

First, in Step S11, the normal-time objective function group definition unit 11a defines the normal-time objective functions Fi(x) (i=1, 2, . . . , N) as indicated in Equation (1-1) to Equation (1-N) below, and stores the definitions in the storage unit 13 as the normal-time objective function definition data 13a. For example, the normal-time objective function F1(x) is the onset probability of diabetes, and the normal-time objective function F2(x) is the onset probability of hypertension. Each normal-time objective function Fi(x) represents a relation between the infection situation of disease of each subject and each explanatory factor.

$$F 1 ( x ) = f 1 ( q 11 \times E 1 ( x ) + ⋯ + q 1 m \times Em ( x ) ) \qquad ( 1 - 1 )$$

$$F 2 ( x ) = f 1 ( q 21 \times E 1 ( x ) + ⋯ + q 2 m \times Em ( x ) ) \qquad ( 1 - 2 )$$

$$…$$

$$F N ( x ) = f 1 ( q N 1 \times E 1 ( x ) + ⋯ + q Nm \times Em ( x ) ) \qquad ( 1 - N )$$

In each of Equation (1-1) to Equation (1-N), f1(*) is a function that outputs a factor, and is, for example, a sigmoid function, but may be another function (for example, various activation functions). Each of the explanatory factors Ej(x) (j=1, 2, . . . , m) takes a value “1” when each subject corresponds to this explanatory factor, and takes a value “0” when each subject does not correspond to this explanatory factor. qij (i=1, 2, . . . , N; j=1, 2, . . . , m) represents contribution degrees of the explanatory factors Ej(x) to the normal-time objective functions Fi(x).

Note that assignment of the explanatory factors Ej(x) in the normal-time objective functions Fi(x) is not limited to assignment in a linear form as in Equation (1-1) to Equation (1-N), and may be assignment in such a non-linear form that each explanatory factor Ej(x) multiplied by the relevant contribution degree is separable. In terms of this point, the same applies to the normal-time objective functions Fi(x) in the emergency-time objective function G(x).

As illustrated in FIG. 3A, in the present embodiment, when the normal-time objective function group definition box D11 is expanded, a normal-time objective function group definition input box D111 appears. Moreover, in the selection field D16, there appear spin boxes D16a to D16j and the like each for selecting the definition of each of the normal-time objective functions Fi(x) and the explanatory factors Ej(x). For example, in FIG. 3A, in the spin box D16a, the “onset probability of diabetes” is selected as F1(x). Moreover, for example, in the spin box D16d, the “value of HbA1c≥6.5” is selected as E1(x).

Then, in Step S12, the emergency-time objective function definition unit 11b defines the emergency-time objective function G(x) as indicated in Equation 2 below, and stores the definition in the storage unit 13 as the emergency-time objective function definition data 13b. The emergency-time objective function G(x) represents a relation between a situation of the infection aggravation during an infection pandemic and each normal-time objective function Fi(x).

$$G ( x ) = f 2 ( w 1 \times F 1 ( x ) + ⋯ + wN \times FN ( x ) ) \qquad ( 2 )$$

In Equation (2), f2(*) is a function that outputs a factor, and is, for example, a sigmoid function, but may be another function (for example, various activation functions). The normal-time objective functions Fi(x) are as defined in Equation (1-1) to Equation (1-N). wi represents contribution degrees of Fi(x) to G(x).

As illustrated in FIG. 3B, in the present embodiment, when the emergency-time objective function definition box D12 is expanded, an emergency-time objective function definition input box D121 appears. Moreover, in the selection field D16, there appear spin boxes D16k, D16a to D16c, and the like for displaying the definitions of the emergency-time objective function G(x) and the normal-time objective functions Fi(x).

After that, in Step S13, the prioritized normal-time objective function extraction unit 11c extracts a major explanatory factor of the emergency-time objective function G(x) as the prioritized normal-time objective function Fs(x). Specifically, the prioritized normal-time objective function extraction unit 11c outputs the contribution degrees w1, . . . , and wN through machine learning. Then, as indicated in Equation (3), the prioritized normal-time objective function extraction unit 11c extracts the prioritized normal-time objective function Fs(x) corresponding to an index s that gives the maximum contribution degree ws among the contribution degrees w1, . . . , and WN.

$$Fs ( x ) = f 1 ( qs 1 \times E 1 ( x ) + ⋯ + qsm \times Em ( x ) ) \qquad ( 3 )$$

As illustrated in FIG. 3C, in the present embodiment, when the prioritized normal-time objective function extraction box D13 is expanded, a prioritized normal-time objective function display box D131 appears. Moreover, in the selection field D16, there appear spin boxes D16k, D16a to D16c, and the like for displaying the definitions of the emergency-time objective function G(x) and the normal-time objective functions Fi(x). In addition, in the selection field D16, there appears a spin box D161 for selection of the name of a machine learning data file used for the machine learning in Step S13. Further, in the selection field D16, there appears a machine learning data display D16m for displaying the normal-time objective function extraction learning data 13c corresponding to the file name selected in the spin box D16l. For example, in FIG. 3C, in the spin box D16l, there is selected the normal-time objective function extraction learning data 13c having a file name “test.csv.”

As illustrated in FIG. 3C, in the normal-time objective function extraction learning data 13c, for each subject ID, “1” is set to the normal-time objective function Fi(x) to which the subject corresponds, and “0” is set to the normal-time objective function Fi(x) to which the subject does not correspond. Moreover, “1” is set to the emergency-time objective function G(x) when the subject corresponds to “aggravation of the infection during the infection pandemic,” and “0” is set to the emergency-time objective function G(x) when the subject does not correspond to it. The contribution degrees w1, . . . , and wN of Equation (2) are calculated through the machine learning of the normal-time objective function extraction learning data 13c in Step S13.

After that, in Step S14, the prioritized maximum explanatory factor extraction unit 11d extracts the major explanatory factor of the prioritized normal-time objective function Fs(x) extracted in Step S13, as the prioritized maximum explanatory factor qst. Specifically, the prioritized maximum explanatory factor extraction unit 11d outputs the contribution degrees qs1, . . . , and qsm of Equation (3) through machine learning. Then, the prioritized maximum explanatory factor extraction unit 11d extracts a prioritized maximum explanatory factor Et(x) corresponding to an index t that gives the prioritized maximum explanatory factor qst having the maximum contribution degree among the contribution degrees qs1, . . . , and qsm.

As illustrated in FIG. 3D, in the present embodiment, when the prioritized maximum explanatory factor extraction box D14 is expanded, a prioritized maximum explanatory factor display box D141 appears. Moreover, in the selection field D16, there appears a spin box D16z for displaying the definition of the prioritized normal-time objective function Fs(x). In addition, in the selection field D16, there appear spin boxes D16d to D16j for displaying the definitions of the explanatory factors Ej(x). Further, in the selection field D16, there appears a spin box D160 for selection of the name of a machine learning data file used for the machine learning in Step S14. Moreover, in the selection field D16, there appears a machine learning data display D16p for displaying the prioritized maximum explanatory factor extraction learning data 13d corresponding to the file name selected in the spin box D160. For example, in FIG. 3D, in the spin box D160, there is selected the prioritized maximum explanatory factor extraction learning data 13d having a file name “test2.csv.”

As illustrated in FIG. 3D, in the prioritized maximum explanatory factor extraction learning data 13d, for each subject ID, “1” is set to the explanatory factor Ej(x) to which the subject corresponds, and “0” is set to the explanatory factor Ej(x) to which the subject does not correspond. Further, “1” is set when the subject corresponds to the prioritized normal-time objective function Fs(x), and “0” is set when the subject does not correspond to it. The contribution degrees qs1, . . . , and qsm of Equation (3) are calculated through the machine learning of the prioritized maximum explanatory factor extraction learning data 13d in Step S14.

After that, in Step S15, the normal-time most prioritized countermeasure output unit 11e refers to the explanatory factor countermeasure candidate table 13e to extract the normal-time most prioritized countermeasure Mt corresponding to the prioritized maximum explanatory factor Et(x) extracted in Step S14, and displays it on the display of the input/output unit 14.

As illustrated in FIG. 3E, in the present embodiment, when the normal-time most prioritized countermeasure extraction box D15 is expanded, a normal-time most prioritized countermeasure display box D151 appears. In the selection field D16, the explanatory factor countermeasure candidate table 13e is displayed in an explanatory factor countermeasure candidate table display D16q. In the explanatory factor countermeasure candidate table 13e, there are stored the prioritized maximum explanatory factors Et(x) and the normal-time most prioritized countermeasures Mt in association with each other.

In the first embodiment, it is assumed that the prioritized normal-time objective function Fs(x) that contributes to the emergency-time objective function G(x) the most is the “onset probability of diabetes,” for example. Moreover, for example, it is assumed that the prioritized maximum explanatory factor Et(x) that contributes to the “onset probability of diabetes” the most is a “frequency of drinking ≥5 days per week.” In this case, “substitution by non-alcoholic drink” that improves the “frequency of drinking” is presented as the normal-time most prioritized countermeasure Mt.

### Modification Example of First Embodiment

### 1. Calculation Model in Extraction of Prioritized Maximum Explanatory Factor Et(x)

In the first embodiment, in Step S14 (FIG. 2) of the normal-time most prioritized countermeasure selection processing, the contribution degrees qs1, . . . and qsm of Equation (3) are output in common for all the subject IDs, but may individually be output for each subject ID. That is, the contribution degrees qij may be output through machine learning for each sample of the prioritized maximum explanatory factor extraction learning data 13d. In other words, in determination of the prioritized maximum explanatory factor qst for extracting the prioritized maximum explanatory factor Et(x), the calculation model may be changed for each subject ID. By changing the calculation model used for determining the prioritized maximum explanatory factor qst, for each subject ID in this manner, it is possible to determine, in consideration of individual situation of each subject, the prioritized maximum explanatory factor Et(x) most appropriate for the subject.

### 2. Extraction of Plurality of Prioritized Maximum Explanatory Factors Et(x)

In the first embodiment, in Step S14 (FIG. 2) of the normal-time most prioritized countermeasure selection processing, only one explanatory factor is extracted as the prioritized maximum explanatory factor Et(x). However, the extraction is not limited to this example, and a plurality of explanatory factors may be extracted. For example, for each subject ID, unrealistic ones of the normal-time most prioritized countermeasures Mt are excluded in advance, and, from the remaining normal-time most prioritized countermeasures Mt, the prioritized maximum explanatory factors Et(x) corresponding to a predetermined number of the largest ones of the contribution degrees gs1, . . . , and qsm may be extracted. For example, by applying a method of calculating an importance degree (contribution degree) for each sample (feature vector) disclosed in a well-known document (Japanese Patent No. 6912998), it is possible to extract the prioritized normal-time objective function Fs(x) and the prioritized maximum explanatory factor Et(x) for each subject ID.

Moreover, the magnitude of each contribution degree qij represents importance of the relevant prioritized maximum explanatory factor Et(x) and the countermeasure corresponding to the prioritized maximum explanatory factor Et(x). Thus, by outputting, together with the countermeasure, the priority of the countermeasure corresponding to the explanatory factor Ej(x) which priority depends on the magnitude of the contribution degree qij, it is clarified which countermeasure is to be executed with priority among the plurality of countermeasures.

### Effects of First Embodiment

In the first embodiment described above, the second contribution degrees in the emergency-time objective function are output through the machine learning of the second sample data relating to the emergency-time objective function, and, on the basis of the second contribution degrees, the prioritized normal-time objective function to be optimized with priority is extracted from the normal-time objective functions. As a result, it is clarified which normal-time objective function is to be optimized with priority in order to optimize the emergency-time objective function.

Moreover, in the first embodiment described above, the first contribution degrees in the prioritized normal-time objective function are output through the machine learning of the first sample data relating to the prioritized normal-time objective function, and the explanatory factors corresponding to the predetermined number of first contribution degrees in the descending order of the first contribution degrees are extracted. As a result, it is clarified which explanatory factor is to be optimized with priority in order to optimize the emergency-time objective function and the prioritized normal-time objective function.

Further, in the first embodiment described above, the explanatory factors and the countermeasures for reducing the risk are managed in association with each other, and the countermeasure corresponding to the explanatory factor extracted on the basis of the prioritized normal-time objective function is output. As a result, a specific action to be taken in order to optimize the explanatory factor is clarified.

In addition, in the first embodiment described above, the first contribution degrees are output through the machine learning for each sample of the first sample data. As a result, the prioritized maximum explanatory factor most appropriate for each sample can be determined in consideration of the individual situations of the samples.

Moreover, in the first embodiment described above, together with the countermeasures, the priorities of the countermeasures corresponding to the explanatory factors which priorities depend on the magnitudes of the predetermined number of first contribution degrees are output. As a result, it is clarified which countermeasure is to be taken with priority among the plurality of presented countermeasures.

Furthermore, in the first embodiment described above, the risk is the infection aggravation during an infection pandemic, and each explanatory factor is data relating to the health state of each subject. Each normal-time objective function represents the relation between the infection situation of disease of each subject and each explanatory factor, and the emergency-time objective function represents the relation between the situation of the infection aggravation during the infection pandemic and each normal-time objective function. Accordingly, in order to achieve, as an objective, prevention of the risk of the aggravation of an infected person of an infection during an infection pandemic, the countermeasures to be normally taken by people before the occurrence of the infection pandemic can be clarified.

### Second Embodiment

In a description of a second embodiment given now, a difference from the first embodiment is mainly described, and a redundant description is omitted.

In the second embodiment, in order to achieve, as an objective, a reduction in the number of days of delay in delivery of industrial products by a manufacturer in the event of an earthquake, countermeasures to be normally taken by each supplier, which supplies the manufacturer with components, before the occurrence of the earthquake are searched for and presented.

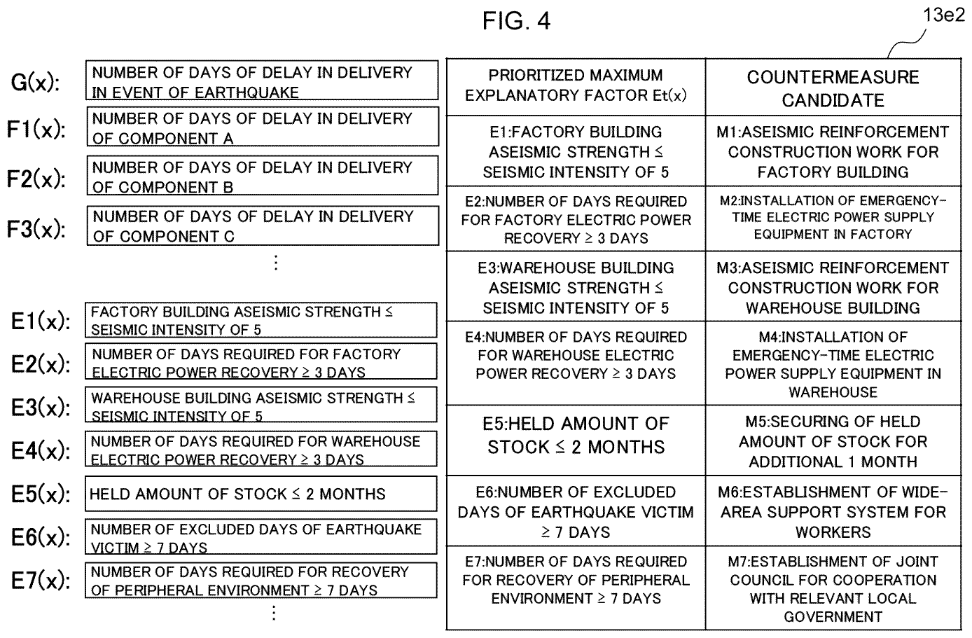

FIG. 4 is a diagram for illustrating the normal-time objective function group, the emergency-time objective function, and the explanatory factors according to the second embodiment.

In the second embodiment, the emergency-time objective function G(x) to be minimized is the “number of days of delay in the delivery (by the manufacturer) in the event of an earthquake.” Moreover, in the second embodiment, the normal-time objective functions Fi(x) that are based on the explanatory factors Ej(x) for each supplier and are to be minimized include the “number of days of delay in delivery of a component A (by the supplier),” the “number of days of delay in delivery of a component B (by the supplier),” and the like. The explanatory factors Ej(x) for each supplier include “factory building aseismic strength≤seismic intensity of 5,” the “number of days required for factory electric power recovery≥3 days,” and the like and are information based on investigation, inspection, questions and answers, and the like targeting each supplier.

In the second embodiment, in place of the explanatory factor countermeasure candidate table 13e, an explanatory factor countermeasure candidate table 13e2 is stored in the storage unit 13. In the second embodiment, it is assumed that the prioritized normal-time objective function Fs(x) that contributes to the emergency-time objective function G(x) the most is the “number of days of delay in the delivery of the component A (in the event of an earthquake),” for example. Moreover, it is assumed that, for example, the prioritized maximum explanatory factor Et(x) that contributes to the “number of days of delay in the delivery of the component A (in the event of an earthquake)” the most is “factory building aseismic strength (of the supplier of the component A)≤seismic intensity of 5.” In this case, “aseismic reinforcement construction work for the factory building (of the supplier of the component A)” that improves the “factory building aseismic strength (of the supplier of the component A)” is presented as the normal-time most prioritized countermeasure Mt.

That is, in the second embodiment, the risk occurring in an emergency is the delay in the delivery of products in the event of an earthquake. Moreover, in the second embodiment, each explanatory factor Ej(x) is data relating to an operation of each factory that produces a component forming each product. Further, in the second embodiment, each normal-time objective function Fi(x) represents a relation between the number of days of delay in the delivery of each component supplied by each factory and each explanatory factor Ej(x). Moreover, in the second embodiment, the emergency-time objective function G(x) represents a relation between the number of days of delay in the delivery of products in the event of an earthquake and each normal-time objective function Fi(x).

### Effects of Second Embodiment

In the second embodiment described above, the risk is the delay in the delivery of products in the event of an earthquake, and each explanatory factor is data relating to the operation of each factory that produces a component forming each product. Moreover, each normal-time objective function represents a relation between the number of days of delay in the delivery of each component supplied by each factory and the explanatory factor, and the emergency-time objective function represents a relation between the number of days of delay in the delivery of products in the event of an earthquake and each normal-time objective function. Accordingly, in order to achieve, as an objective, a reduction in the number of days of delay in the delivery of industrial products by the manufacturer in the event of an earthquake, it is possible to clarify the countermeasures to be normally taken by each supplier, which supplies the manufacturer with a component, before the occurrence of the earthquake.

Note that the embodiments described above are detailed for the sake of an easy-to-understand description of the present invention and that the present invention is not necessarily limited to the embodiments including all the described configurations. Moreover, a part of a configuration of a certain embodiment can be replaced by a configuration of another embodiment, and a configuration of a certain embodiment can be added to a configuration of another embodiment. In addition, as to a part of a configuration of each of the embodiments, another configuration can be added, the part can be deleted, or the part can be replaced by another configuration. A part or all of each of the configurations, functions, processing units, processing means, and the like described above may be implemented as hardware through, for example, design using an integrated circuit or the like. Moreover, each of the configurations, functions, and the like described above may be implemented as software by a processor interpreting and executing a program that implements each function. Furthermore, information such as a program, a table, a file, and the like for implementing each configuration may be retained in a recording device such as a memory, a hard disk, or a solid state drive (SSD) or in a recording medium such as an integrated circuit (IC) card, a secure digital (SD) card, or a digital versatile disc (DVD).

What is claimed is:

1. A risk analysis method executed by a risk analysis system that executes risk analysis for reducing a risk that occurs in an emergency, the risk analysis method comprising:
by a processor of the risk analysis system,
defining a plurality of normal-time objective functions each of which is an objective function representing an objective to be normally achieved and has, as input to a predetermined function that outputs a predetermined value in response to the input, a predetermined equation that includes, as first-order terms or factors, a plurality of explanatory factors each multiplied by a first contribution degree relating to the relevant explanatory factor;
defining an emergency-time objective function that is an objective function representing an objective to be achieved in order to reduce the risk, as a function that outputs a value in response to input, the input being a predetermined equation including, as first-order terms or factors, the plurality of normal-time objective functions each multiplied by a second contribution degree relating to the relevant normal-time objective function; and
outputting the second contribution degrees in the emergency-time objective function through machine learning of second sample data relating to the emergency-time objective function and extracting, on a basis of the second contribution degrees, a prioritized normal-time objective function to be optimized with priority from the normal-time objective functions.

2. The risk analysis method according to claim 1, further comprising:
by the processor,
outputting the first contribution degrees in the prioritized normal-time objective function through machine learning of first sample data relating to the prioritized normal-time objective function and extracting the explanatory factors corresponding to a predetermined number of first contribution degrees in a descending order of the first contribution degrees.

3. The risk analysis method according to claim 2, further comprising:
by the processor,
managing the explanatory factors and countermeasures for reducing the risk in association with each other; and
outputting the countermeasures corresponding to the extracted explanatory factors.

4. The risk analysis method according to claim 2,
wherein the processor outputs the first contribution degrees through machine learning for each sample of the first sample data.

5. The risk analysis method according to claim 3,
wherein the processor outputs, together with the countermeasures, priorities of the countermeasures corresponding to the explanatory factors which priorities depend on magnitudes of the predetermined number of first contribution degrees.

6. The risk analysis method according to claim 3,
wherein the risk is infection aggravation during an infection pandemic,
each of the explanatory factors is data relating to a health state of each subject,
each of the normal-time objective functions represents a relation between an infection situation of disease of each subject and each explanatory factor, and
the emergency-time objective function represents a relation between a situation of the infection aggravation during the infection pandemic and each normal-time objective function.

7. The risk analysis method according to claim 3,
wherein the risk is delay in delivery of a product in an event of an earthquake,
each of the explanatory factors is data relating to an operation of each factory that produces a component forming the product,
each of the normal-time objective functions represents a relation between number of days of delay in delivery of each component supplied by each factory and each explanatory factor, and
the emergency-time objective function represents a relation between number of days of delay in the delivery of the product in the event of the earthquake and each normal-time objective function.

8. A risk analysis system that executes risk analysis for reducing a risk that occurs in an emergency,
wherein a processor of the risk analysis system
defines a plurality of normal-time objective functions each of which is an objective function representing an objective to be normally achieved and has, as input to a predetermined function that outputs a predetermined value in response to the input, a predetermined equation that includes, as first-order terms or factors, a plurality of explanatory factors each multiplied by a first contribution degree relating to the relevant explanatory factor,
defines an emergency-time objective function that is an objective function representing an objective to be achieved in order to reduce the risk, as a function that outputs a value in response to input, the input being a predetermined equation including, as first-order terms or factors, the plurality of normal-time objective functions each multiplied by a second contribution degree relating to the relevant normal-time objective function, and
outputs the second contribution degrees in the emergency-time objective function through machine learning of second sample data relating to the emergency-time objective function and extracts, on a basis of the second contribution degrees, a prioritized normal-time objective function to be optimized with priority from the normal-time objective functions.

9. The risk analysis system according to claim 8,
wherein the processor outputs the first contribution degrees in the prioritized normal-time objective function through machine learning of first sample data relating to the prioritized normal-time objective function and extracts the explanatory factors corresponding to a predetermined number of first contribution degrees in a descending order of the first contribution degrees.

10. The risk analysis system according to claim 9,
wherein the processor
manages the explanatory factors and countermeasures for reducing the risk in association with each other, and
outputs the countermeasures corresponding to the extracted explanatory factors.

11. The risk analysis system according to claim 9,
wherein the processor outputs the first contribution degrees through machine learning for each sample of the first sample data.

12. The risk analysis system according to claim 10,
wherein the processor outputs, together with the countermeasures, priorities of the countermeasures corresponding to the explanatory factors which priorities depend on magnitudes of the predetermined number of first contribution degrees.

13. The risk analysis system according to claim 10,
wherein the risk is infection aggravation during an infection pandemic,
each of the explanatory factors is data relating to a health state of each subject,
each of the normal-time objective functions represents a relation between an infection situation of each disease of each subject and each explanatory factor, and
the emergency-time objective function represents a relation between a situation of the infection aggravation during the infection pandemic and each normal-time objective function.

14. The risk analysis system according to claim 10,
wherein the risk is delay in delivery of a product in an event of an earthquake,
each of the explanatory factors is data relating to an operation of each factory that produces a component forming the product,
each of the normal-time objective functions represents a relation between number of days of delay in delivery of each component supplied by each factory and each explanatory factor, and
the emergency-time objective function represents a relation between number of days of delay in the delivery of the product in the event of the earthquake and each normal-time objective function.
